(19) United States
(12) Patent Application Publication
(10) Pub. No.: US 2022/0031136 A1
(43) Pub. Date: Feb. 3, 2022

(54) VACUUM CLEANER SYSTEM AND VACUUM CLEANER

(71) Applicant: PANASONIC INTELLECTUAL PROPERTY MANAGEMENT CO., LTD., Osaka (JP)

(72) Inventors: Yuta MIURA, Osaka (JP); Hiroyuki MOTOYAMA, Osaka (JP); Takehiro TANAKA, Osaka (JP); Yuko TSUSAKA, Kyoto (JP)

(21) Appl. No.: 17/380,263

(22) Filed: Jul. 20, 2021

(30) Foreign Application Priority Data
Jul. 29, 2020 (JP) 2020-128735

(51) Int. Cl. A47L 9/28; A47L 9/00; G05D 1/02

(52) U.S. Cl. CPC A47L 9/2805; A47L 9/009; G05D 2201/0215; G05D 1/0212; A47L 2201/04; A47L 9/2852

(57) ABSTRACT

A vacuum cleaner system includes a position sensor that acquires a positional relationship between the vacuum cleaner and an object around the vacuum cleaner, a map acquisition unit that acquires a floor map indicating the predetermined floor, a self-position estimation unit that estimates a self-position on the floor map based on the position sensor, the self-position being a position of the vacuum cleaner, a boundary information generation unit that acquires, based on the self-position, boundary information indicating a boundary of a cleaning area which is an area where the vacuum cleaner performs cleaning on the floor, a boundary instruction unit that instructs the boundary information generation unit on the boundary, a cleaning area creation unit that creates a cleaning area based on the boundary information, and a running route creation unit that creates a running route for cleaning based on the created cleaning area.

### BACKGROUND

### 1. Technical Field

The present disclosure relates to a vacuum cleaner system including a vacuum cleaner capable of cleaning a common area such as a hallway of a public facility or office building while autonomously running and a vacuum cleaner used in the vacuum cleaner system.

### 2. Description of the Related Art

CN 106175606 A (to be referred to as “Patent Literature 1” hereinafter) discloses an autonomous vacuum cleaner that performs cleaning running while searching for an uncleaned area for each rectangular area of a mesh with predetermined intervals.

However, it is difficult to match a virtually determined mesh with an actual floor, and it is difficult to cause an autonomous vacuum cleaner to perform efficient cleaning.

### SUMMARY

The present disclosure provides a vacuum cleaner system and a vacuum cleaner that can easily set a cleaning area corresponding to an actual floor.

The present disclosure is a vacuum cleaner system including a vacuum cleaner that cleans a predetermined floor while autonomously running. This vacuum cleaner system includes a position sensor that acquires a positional relationship between the vacuum cleaner and an object around the vacuum cleaner, a map acquisition unit that acquires a floor map indicating the predetermined floor, a self-position estimation unit that estimates a self-position on the floor map based on the position sensor, the self-position being a position of the vacuum cleaner, a boundary information generating unit that acquires, based on the self-position, boundary information indicating a boundary of a cleaning area which is an area where the vacuum cleaner performs cleaning on the floor, a boundary instruction unit that instructs the boundary information generating unit on the boundary, a cleaning area creation unit that creates a cleaning area based on the boundary information, and a running route creation unit that creates a running route for cleaning based on the created cleaning area.

The present disclosure is a vacuum cleaner included in the vacuum cleaner system. The vacuum cleaner includes the position sensor, the map acquisition unit, the self-position estimation unit, the boundary information generating unit, and the boundary instruction unit.

According to the present disclosure, it is possible to provide a vacuum cleaner system and a vacuum cleaner that can easily set a cleaning area corresponding to a floor and shorten a running plan creation time.

### BRIEF DESCRIPTION OF THE DRAWINGS

FIG. 1 is a plan view illustrating a vacuum cleaner system according to an exemplary embodiment together with an example of a cleaning target floor;

FIG. 2 is a view illustrating an example of a side surface of an external appearance of a vacuum cleaner according to the exemplary embodiment;

FIG. 3 is a view illustrating an example of a bottom surface of an external appearance of the vacuum cleaner according to the exemplary embodiment;

FIG. 4 is a block diagram illustrating each functional unit of the vacuum cleaner system according to the exemplary embodiment;

FIG. 5 is a diagram illustrating an example of icons displayed on a terminal device according to the exemplary embodiment;

FIG. 6 is a flowchart illustrating a processing procedure in the vacuum cleaner system according to the exemplary embodiment;

FIG. 7 is a first plan view illustrating an example of boundary information creation according to the exemplary embodiment;

FIG. 8 is a second plan view illustrating an example of boundary information creation according to the exemplary embodiment;

FIG. 9 is a third plan view illustrating an example of boundary information creation according to the exemplary embodiment;

FIG. 10 is a plan view illustrating an example of the created first cleaning area according to the exemplary embodiment;

FIG. 11 is a plan view illustrating an example of a state in which an entire floor is divided into cleaning areas according to the exemplary embodiment;

FIG. 12 is a plan view illustrating another mode of instructing on boundaries;

FIG. 13 is a perspective view illustrating a boundary acquisition device; and

FIG. 14 is a block diagram illustrating each functional unit of the vacuum cleaner system including the boundary acquisition device.

### DETAILED DESCRIPTION

An exemplary embodiment of a vacuum cleaner system and a vacuum cleaner included in the vacuum cleaner system according to the present disclosure will be described next with reference to the accompanying drawings. Note that the following exemplary embodiments are merely examples of the vacuum cleaner system and the vacuum cleaner according to the present disclosure. Accordingly, the scope of the present disclosure is defined by the wording of the claims with reference to the following embodiments and is not limited only to the following embodiments. Therefore, among the constituent elements in the following exemplary embodiments, constituent elements not described in the independent claims indicating the highest concept of the present disclosure are not necessarily required to achieve the object of the present disclosure, but are described as constituting a more preferable mode.

In addition, the drawings are schematic views in which emphasis, omission, and ratio adjustment are appropriately performed in order to indicate the present disclosure, and may be different from actual shapes, positional relationships, and ratios.

### Exemplary Embodiment

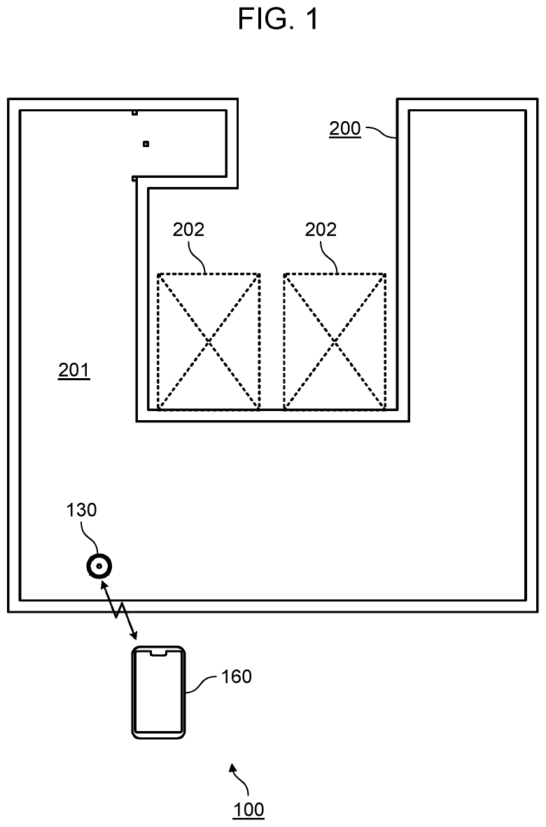

Vacuum cleaner system 100 and vacuum cleaner 130 according to an exemplary embodiment of the present disclosure will be described below with reference to FIGS. 1 to 11.

FIG. 1 is a plan view illustrating vacuum cleaner system 100 according to an exemplary embodiment together with an example of a cleaning target floor. As illustrated in FIG. 1, vacuum cleaner system 100 creates a running route included in a cleaning plan of a floor 201 surrounded by walls of facility 200 such as a hotel or tenant building. Vacuum cleaner 130 then autonomously runs and cleans according to the created cleaning plan. In the present exemplary embodiment, vacuum cleaner system 100 includes vacuum cleaner 130 and terminal device 160.

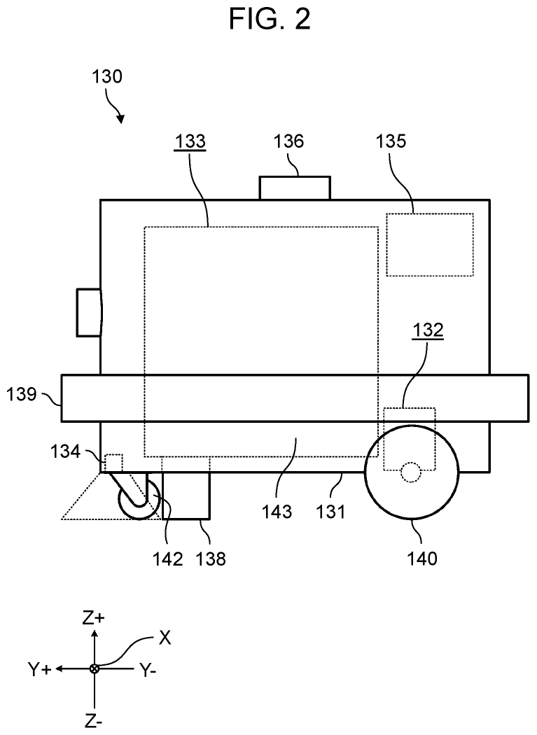

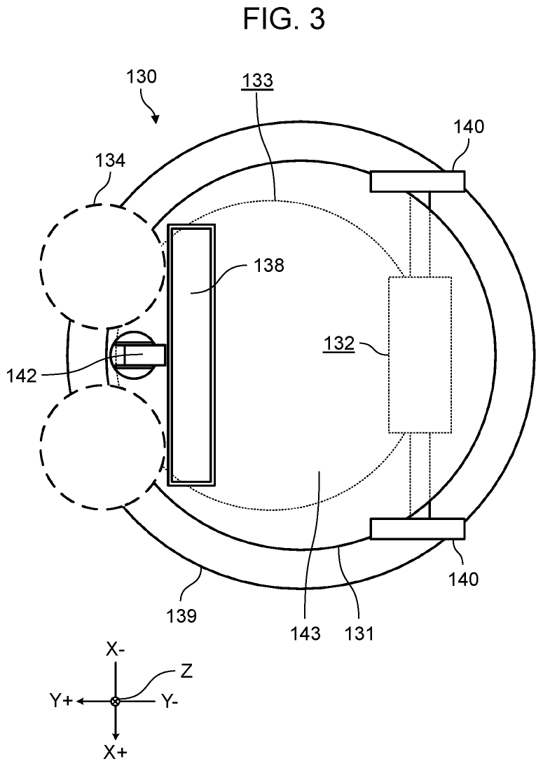

FIG. 2 is a view illustrating an example of a side surface of an external appearance of vacuum cleaner 130 according to the exemplary embodiment. FIG. 3 is a view illustrating an example of a bottom surface of an external appearance of vacuum cleaner 130 according to the exemplary embodiment. As illustrated in these drawings, vacuum cleaner 130 according to the exemplary embodiment is a robot type vacuum cleaner. Vacuum cleaner 130 segments floor 201, which is a cleaning target area of, into a plurality of cleaning areas, such as a common area of floor 201, and autonomously runs in a determined cleaning area to suck dust.

In the present exemplary embodiment, as illustrated in FIGS. 2 and 3, vacuum cleaner 130 includes body 131 on which various constituent elements are mounted, running unit 132 that moves body 131, cleaning unit 133 that cleans dust on floor 201, controller 135 that controls running unit 132 and cleaning unit 133, and position sensor 136.

Body 131 is a housing that houses running unit 132, controller 135, and the like. Body 131 has a configuration in which an upper portion is detachable from a lower portion. Bumper 139 displaceable with respect to body 131 is attached to an outer peripheral portion of body 131. As illustrated in FIG. 3, body 131 is provided with suction port 138 for sucking dust into body 131.

Running unit 132 causes vacuum cleaner 130 to run based on an instruction from controller 135. In the present exemplary embodiment, vacuum cleaner 130 includes position sensor 136, and running unit 132 also functions as a device that moves position sensor 136. Running unit 132 includes wheels 140 running on the floor and a running motor (not illustrated) that applies torque to wheels 140. Caster 142 is provided as an auxiliary wheel on the bottom surface of body 131. Controller 135 independently controls the rotation of two wheels 140, so that vacuum cleaner 130 can freely run. For example, vacuum cleaner 130 can move straight and backward and rotate clockwise and counterclockwise.

Cleaning unit 133 sucks dust from suction port 138 and holds the sucked dust in body 131. Cleaning unit 133 includes an electric fan (not illustrated) and dust holder 143. The electric fan sucks air inside dust holder 143 and discharges the air to the outside of body 131 to suck dust from suction port 138 and store the dust in dust holder 143. Cleaning unit 133 includes rotary brush 134 for sweeping and collecting dust and sucking dust from suction port 138. Cleaning unit 133 may be configured to perform wiping-type cleaning. When cleaning unit 133 is configured to perform wiping-type cleaning, cleaning unit 133 includes a cloth or mop for wiping and a wiping motor for operating the cloth or mop. Note that cleaning unit 133 may be configured to implement both suction-type cleaning and wiping-type cleaning.

Position sensor 136 detects the positional relationship between vacuum cleaner 130 and an object including a wall or the like present on a peripheral edge of vacuum cleaner 130 in floor 201. This positional relationship includes the distance from vacuum cleaner 130 to the object and the direction of the object with respect to vacuum cleaner 130. Furthermore, self-position estimation unit 172 (to be described later) can grasp the position of vacuum cleaner 130 itself (to be also referred to as the self-position hereinafter) from information on the direction and the distance detected by position sensor 136. The type of position sensor 136 is not particularly limited. Examples of position sensor 136 can include a light detection and ranging (LiDAR) camera that emits light and detects a position and a distance on the basis of the light reflected by an obstacle and a time of flight (ToF) camera. Furthermore, as position sensor 136, for example, a compound-eye camera that acquires illumination light or natural light reflected by an obstacle as an image and acquires a position and a distance on the basis of parallax can be exemplified.

Note that vacuum cleaner 130 may include a sensor in addition to position sensor 136. Vacuum cleaner 130 may include, for example, floor surface sensors that are disposed at a plurality of locations on the bottom surface of body 131 and detect whether or not a floor surface as floor 201 is present. Further, vacuum cleaner 130 may include an encoder that is provided in running unit 132 and detects the rotation angle of each of the pair of wheels 140 rotated by the running motor. Further, vacuum cleaner 130 may include an acceleration sensor that detects the acceleration of vacuum cleaner 130 when it runs and an angular velocity sensor that detects the angular velocity of vacuum cleaner 130 when it turns. Vacuum cleaner 130 may also include a dust amount sensor that measures the amount of dust deposited on the floor surface. Vacuum cleaner 130 may also include a contact sensor that detects collision of vacuum cleaner 130 with an obstacle by detecting the displacement of bumper 139. Further, vacuum cleaner 130 may include an obstacle sensor such as an ultrasonic sensor, other than position sensor 136, which detects an obstacle present in front of body 131.

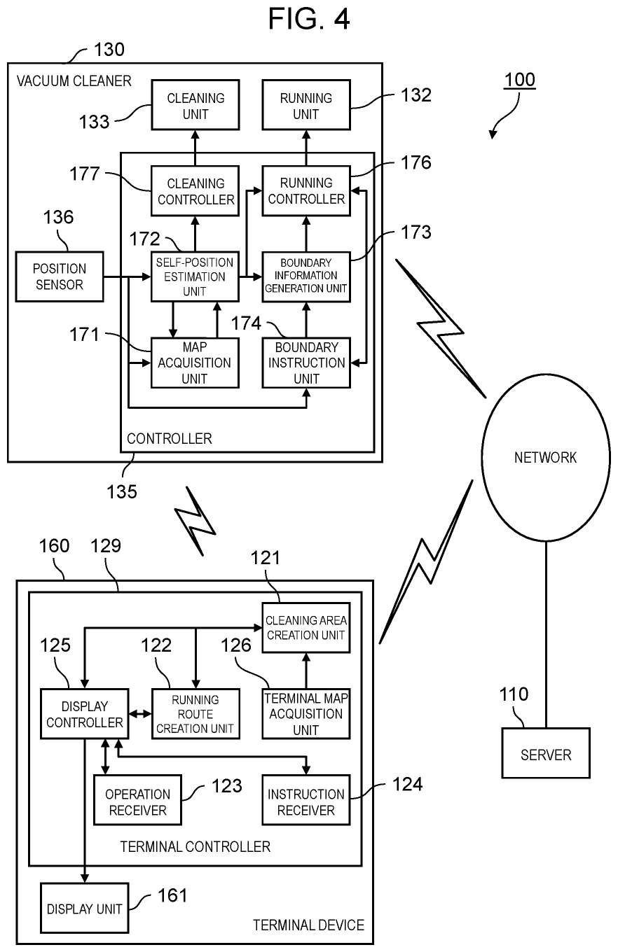

FIG. 4 is a block diagram illustrating each functional unit of vacuum cleaner system 100 according to the exemplary embodiment. As illustrated in FIG. 4, vacuum cleaner system 100 includes map acquisition unit 171, self-position estimation unit 172, boundary information generating unit 173, and boundary instruction unit 174 as processing units implemented by causing a processor of controller 135 to execute programs. In the present exemplary embodiment, controller 135 includes running controller 176 and cleaning controller 177.

Map acquisition unit 171 acquires a floor map on the basis of the information obtained by measuring the position of an object and the distance to the object with position sensor 136. Map acquisition unit 171 may acquire a floor map from terminal device 160, server 110, or the like. In the present exemplary embodiment, map acquisition unit 171 creates a floor map regarding the surrounding environment of vacuum cleaner 130 by, for example, simultaneous localization and mapping (SLAM) technology on the basis of the information acquired from position sensor 136. The surrounding environment includes, for example, walls and furniture.

Note that vacuum cleaner 130 may create a floor map using information from a wheel odometry, a gyro sensor, or the like that is another sensor in addition to the sensing information obtained by position sensor 136 as a LiDAR sensor.

Self-position estimation unit 172 estimates a self-position using the relative positional relationship between the object and position sensor 136 acquired from position sensor 136 and the floor map. In the present exemplary embodiment, self-position estimation unit 172 estimates a self-position using the SLAM technology. That is, map acquisition unit 171 and self-position estimation unit 172 create a floor map while estimating a self-position using SLAM and sequentially update the self-position and the floor map.

Boundary information generating unit 173 generates boundary information on the basis of the self-position generated by self-position estimation unit 172. Boundary information indicates a boundary of a cleaning area that is an area where vacuum cleaner 130 performs cleaning on floor 201. For example, using the information acquired from boundary instruction unit 174 as a trigger, boundary information generating unit 173 may generate, as a boundary, a virtual axis line that is in a direction orthogonal to the straight ahead direction of vacuum cleaner 130 on a horizontal plane (that is, the widthwise direction) and includes the self-position. Furthermore, boundary information generating unit 173 may generate a rectangular boundary. Upon acquiring information from boundary instruction unit 174 when vacuum cleaner 130 has moved to the next place, boundary information generating unit 173 may generate this rectangular boundary, in response to the information acquired from boundary instruction unit 174 as a trigger, with the self-position as one corner of the rectangle, by determining the next self-position as an opposite corner of the rectangle. Note that a specific method of acquiring a boundary will be described later.

Boundary instruction unit 174 instructs information generating unit 173 on a boundary. Boundary instruction unit 174 may instruct boundary information generating unit 173 on a boundary when acquiring information indicating that the running direction of vacuum cleaner 130, that is, the running direction of position sensor 136, has changed by a predetermined angle (for example, 90°). In addition, boundary instruction unit 174 may instruct boundary information generating unit 173 on a boundary on the basis of the detection of a marker arranged on floor 201, a wall surface surrounding floor 201, or the like. Further, boundary instruction unit 174 may instruct boundary information generating unit 173 on a boundary based on an input from the user.

Running controller 176 causes vacuum cleaner 130 to run along the cleaning route based on the self-position estimated by self-position estimation unit 172. Note that, when the sensor acquires information indicating that there is an object that obstructs the running of vacuum cleaner 130 on the running route, running controller 176 may control running unit 132 to cause vacuum cleaner 130 to run while avoiding the object.

Cleaning controller 177 causes cleaning unit 133 to perform cleaning corresponding to the self-position based on a cleaning plan. For example, cleaning controller 177 changes, for example, the suction force and whether to rotate the brush on the basis of the self-position.

Terminal device 160 includes a communication device (not illustrated) capable of performing communication with vacuum cleaner 130 and communication via a network and processes the information acquired by the communication device. Terminal device 160 includes display unit 161 that can display the processed information to the user and terminal controller 129. As terminal device 160, for example, a so-called smartphone, a so-called tablet, a so-called notebook personal computer, a so-called desktop personal computer, or the like can be exemplified. Terminal device 160 includes cleaning area creation unit 121 and running route creation unit 122 as processing units implemented by executing programs in a processor (not illustrated) included in terminal controller 129. In the present exemplary embodiment, terminal controller 129 includes operation receiver 123, instruction receiver 124, display controller 125, and terminal map acquisition unit 126.

Cleaning area creation unit 121 creates a cleaning area for creating a running route of vacuum cleaner 130 based on the boundary information generated by boundary information generating unit 173. Cleaning area creation unit 121 may create a cleaning area using the floor map or the like acquired by terminal map acquisition unit 126.

Running route creation unit 122 creates a running route for making vacuum cleaner 130 perform cleaning based on the cleaning area created by cleaning area creation unit 121. Running route creation unit 122 may automatically create a running route using a predetermined algorithm. Running route creation unit 122 may create a running route by an input from the user. In addition, running route creation unit 122 may correct the created running route by an input from the user.

In the present exemplary embodiment, running route creation unit 122 can also create a cleaning plan. A cleaning plan is information including a cleaning area which is at least one of the areas of floor 201 which are segmented by boundary information, a running route of vacuum cleaner 130 in the cleaning area, and information indicating a cleaning mode corresponding to the position of vacuum cleaner 130. The cleaning mode includes, for example, the suction force of cleaning unit 133 and the running speed of vacuum cleaner 130 by running unit 132. A specific example of the cleaning plan created by running route creation unit 122 will be described hereinafter. For example, as illustrated in FIG. 1, an area in front of elevator 202 is assumed to be an area through which most people pass. Accordingly, it is desirable to enhance the cleaning mode in the area in front of elevator 202 as compared with other areas. Therefore, the area in front of the elevator 202 is set as an area where the cleaning mode is enhanced as compared with other areas. Such information becomes part of the cleaning plan.

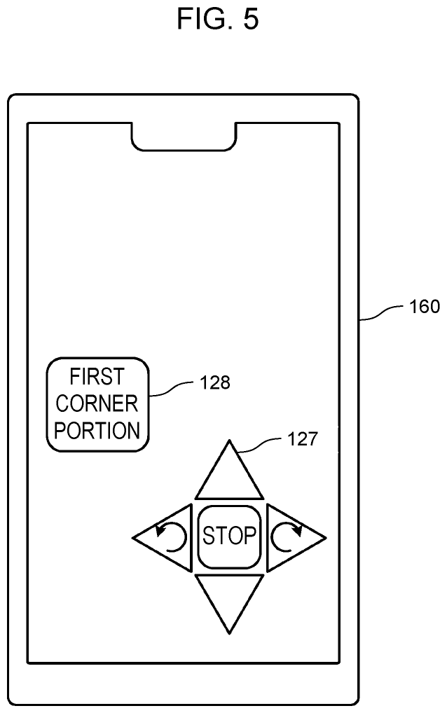

Operation receiver 123 receives an input from a user and generates information for moving vacuum cleaner 130, that is, information for moving position sensor 136. In the present exemplary embodiment, display unit 161, display controller 125, and operation receiver 123 constitute a graphical user interface (GUI) as an operation unit. FIG. 5 is a diagram illustrating an example of icons displayed on terminal device 160 according to the exemplary embodiment. As illustrated in FIG. 5, display controller 125 of the operation unit displays first icon 127 indicating a direction on display unit 161. Display unit 161 includes a touch panel. Operation receiver 123 acquires information for distinguishing one of first icons 127 which is touched by the user via display controller 125 and outputs information indicating a direction corresponding to first icon 127 touched by the user. Running controller 176 of vacuum cleaner 130 which has acquired the information controls running unit 132 in accordance with the information to move position sensor 136. The operation unit including operation receiver 123 can remotely control the running of vacuum cleaner 130 in accordance with an input from the user.

Instruction receiver 124 receives an instruction from the user instructing on one and the other of the opposing corners of the rectangular area and outputs the information acquired by boundary instruction unit 174. In the present exemplary embodiment, display unit 161, display controller 125, and instruction receiver 124 also constitute a GUI. As illustrated in FIG. 5, display controller 125 displays second icon 128 indicating the “corner portion” on display unit 161. For example, when the user operates (touches) second icon 128 displayed as the “first corner portion” illustrated in FIG. 5, display controller 125 changes the display of second icon 128 to the “second corner portion” (not illustrated). Subsequently, when the user operates (touches) second icon 128 displayed as the “second corner portion”, display controller 125 changes the display of second icon 128 to the “first corner portion”.

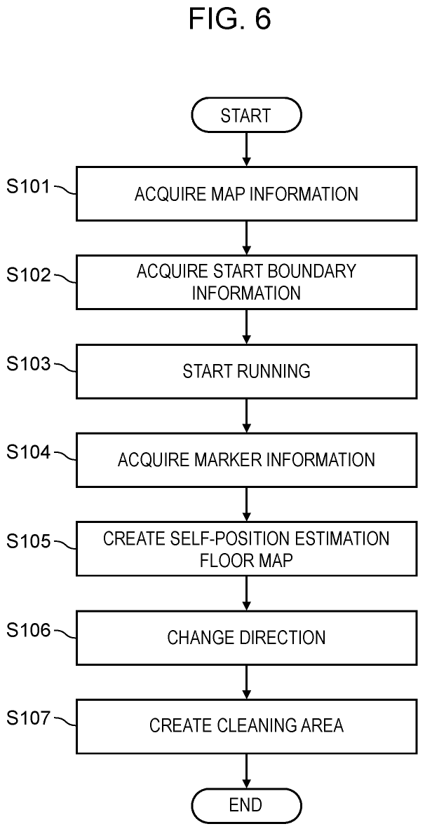

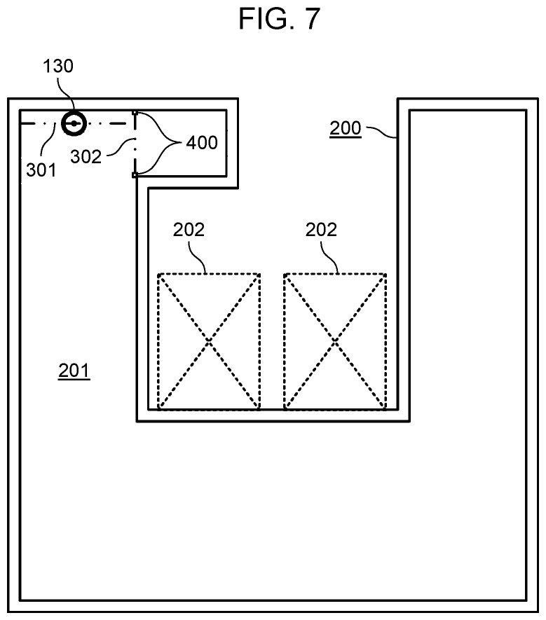

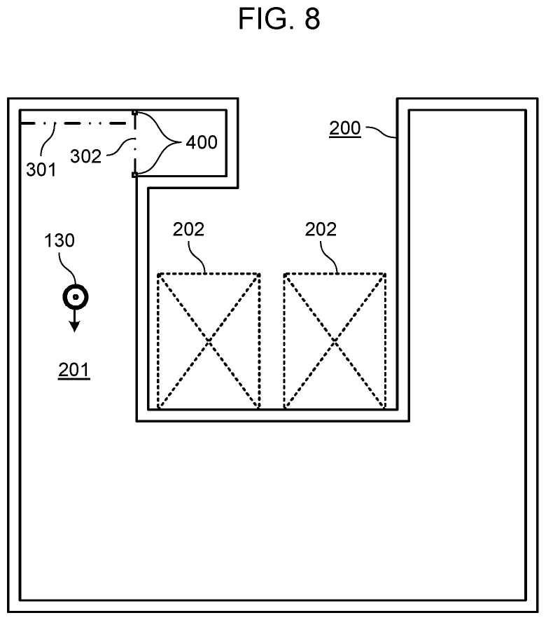

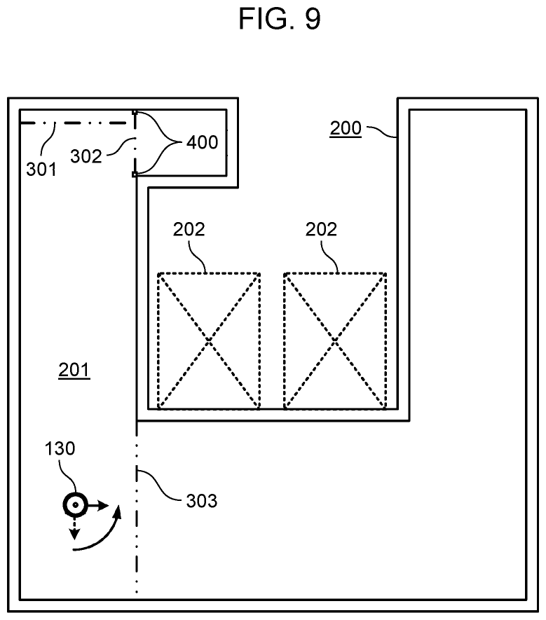

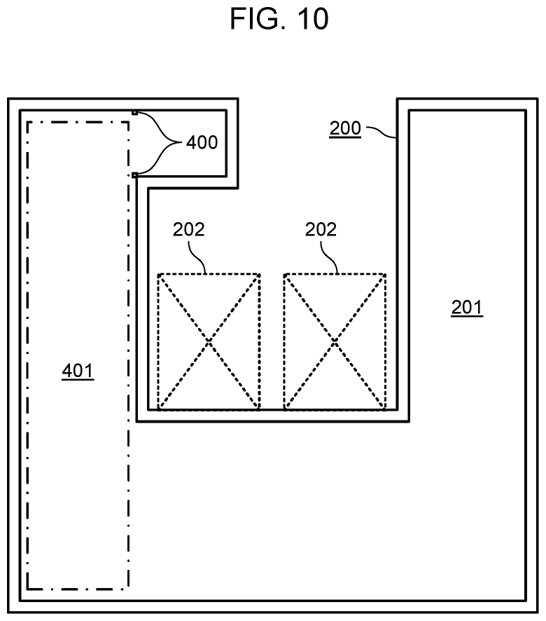

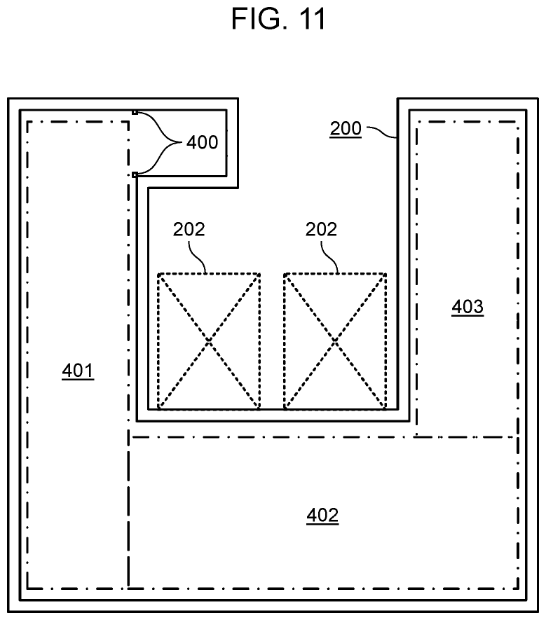

The operation of vacuum cleaner system 100 will be described next with reference to FIGS. 6 to 11. FIG. 6 is a flowchart illustrating a processing procedure in vacuum cleaner system 100 according to the exemplary embodiment. FIG. 7 is a first plan view illustrating an example of boundary information creation according to the exemplary embodiment. FIG. 8 is a second plan view illustrating an example of boundary information creation according to the exemplary embodiment. FIG. 9 is a third plan view illustrating an example of boundary information creation according to the exemplary embodiment. FIG. 10 is a plan view illustrating an example of the created first cleaning area according to the exemplary embodiment. FIG. 11 is a plan view illustrating an example of a state in which the entire floor is divided into cleaning areas according to the exemplary embodiment.

First, vacuum cleaner system 100 has vacuum cleaner 130 placed at a start position and creates a cleaning area. Map acquisition unit 171 acquires a floor map from server 110 or the like (S101). The floor map acquired at this stage may be a floor map on which information such as furniture arranged on the floor does not exist. Next, boundary instruction unit 174 instructs boundary information generating unit 173 on information indicating that the current position is a boundary indicating the start of cleaning, and boundary information generating unit 173 acquires boundary information (first boundary line 301 illustrated in FIG. 7) based on the information from position sensor 136.

Next, vacuum cleaner 130 starts running (S103). The running of vacuum cleaner 130 may be started by, for example, the user operating first icon 127 of terminal device 160.

In this case, as illustrated in FIG. 7, when a sensor included in vacuum cleaner 130, such as position sensor 136, detects no-entry marker 400 set on a floor or wall, vacuum cleaner system 100 acquires no-entry boundary 302. When vacuum cleaner 130 detects no-entry marker 400 during running, boundary information corresponding to detected no-entry marker 400 is sometimes acquired.

As illustrated in FIG. 8, while vacuum cleaner 130 is running (for example, running straight), map acquisition unit 171 and self-position estimation unit 172 create a floor map while recognizing the self-position by the SLAM technique (S105). In this case, when furniture, a decorative object, or the like is placed on the floor, map acquisition unit 171 may update the floor map corresponding to the shape of the furniture, decorative object, or the like.

When the user operates first icon 127 of terminal device 160 to change the running direction of vacuum cleaner 130 on which position sensor 136 is mounted (by, for example, 90°) as illustrated in FIG. 9 upon the arrival of vacuum cleaner 130 at an end portion of a desired cleaning area, operation receiver 123 acquires information based on the operation via display controller 125 (S106). Accordingly, the running direction of vacuum cleaner 130 is changed (by 90° in the example illustrated in FIG. 9).

Next, boundary instruction unit 174 acquires information indicating that the running direction of vacuum cleaner 130 on which position sensor 136 is mounted has changed by a predetermined angle (for example, 90°) and instructs boundary information generator 173 on a boundary indicating the end of the cleaning area. Boundary information generating unit 173 acquires boundary information (third boundary line 303 in the example illustrated in FIG. 9) based on information from position sensor 136.

Cleaning area creation unit 121 creates first cleaning area 401 as illustrated in FIG. 10 based on each piece of boundary information generated by boundary information generating unit 173, the floor map acquired first, the floor map created by the SLAM technique, and the like (S107).

Vacuum cleaner system 100 repeatedly performs the same operation as described above and creates second cleaning area 402 and third cleaning area 403 for entire floor 201 as illustrated in FIG. 11.

Running route creation unit 122 may create a running route using the cleaning area created each time a cleaning area is created, or may create a running route for each cleaning area after creating a cleaning area for entire floor 201.

In vacuum cleaner system 100 according to the present exemplary embodiment, floor 201 can be divided into a plurality of cleaning areas while the user checks an actual condition of floor 201. Therefore, in vacuum cleaner system 100, the running route created based on a cleaning area and a cleaning plan including the running route are adapted to actual floor 201, and it is possible to suppress the occurrence of an area where cleaning cannot be performed or cleaning beyond no-entry boundary 302. In addition, vacuum cleaner system 100 can shorten the creation time of a running route and the creation time of a cleaning plan as compared with the related art.

Note that the present disclosure is not limited to the above exemplary embodiment. For example, another exemplary embodiment implemented by arbitrarily combining the constituent elements described in the present specification or excluding some of the constituent elements may be an exemplary embodiment of the present disclosure. The present disclosure also includes modifications obtained by making various modifications conceivable by those skilled in the art without departing from the spirit of the present disclosure, that is, the meaning indicated by the wording described in the claims.

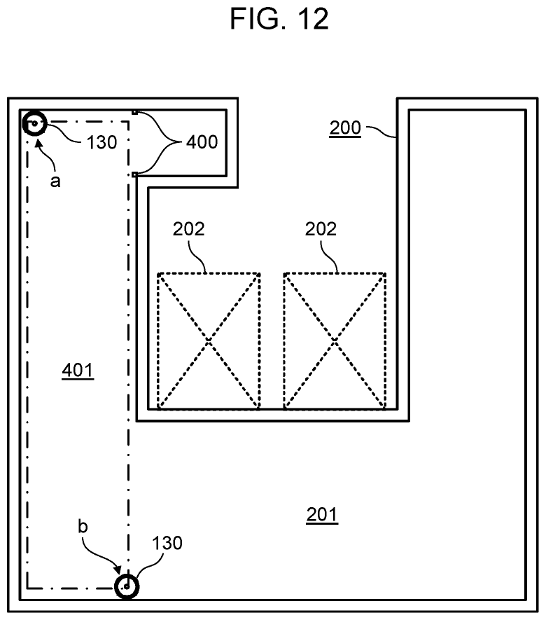

FIG. 12 is a plan view illustrating another mode of instructing on boundaries. For example, as illustrated in FIG. 12, first, upon arrival of vacuum cleaner 130 at point a, instruction receiver 124 may output information representing the first corner portion of rectangular first cleaning area 401 to boundary instruction unit 174 when the user touches second icon 128 of terminal device 160. Next, upon arrival of vacuum cleaner 130 at point b, instruction receiver 124 may output information representing the second corner portion of first cleaning area 401 to boundary instruction unit 174 when the user touches second icon 128 of terminal device 160. Accordingly, boundary instruction unit 174 may instruct boundary information generating unit 173 to create a boundary, and boundary information generating unit 173 may create a boundary of rectangular first cleaning area 401 based on the information from position sensor 136.

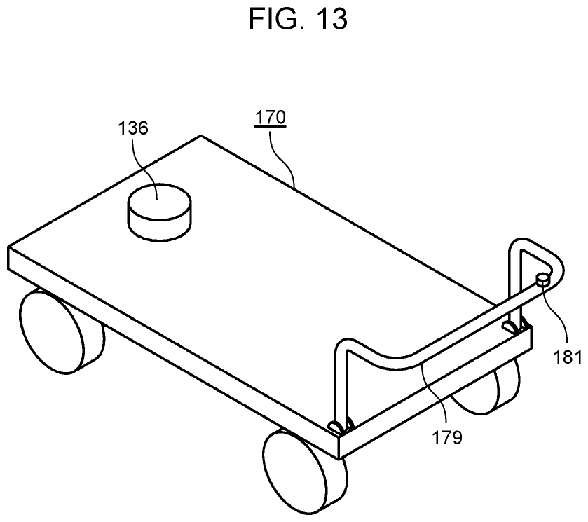

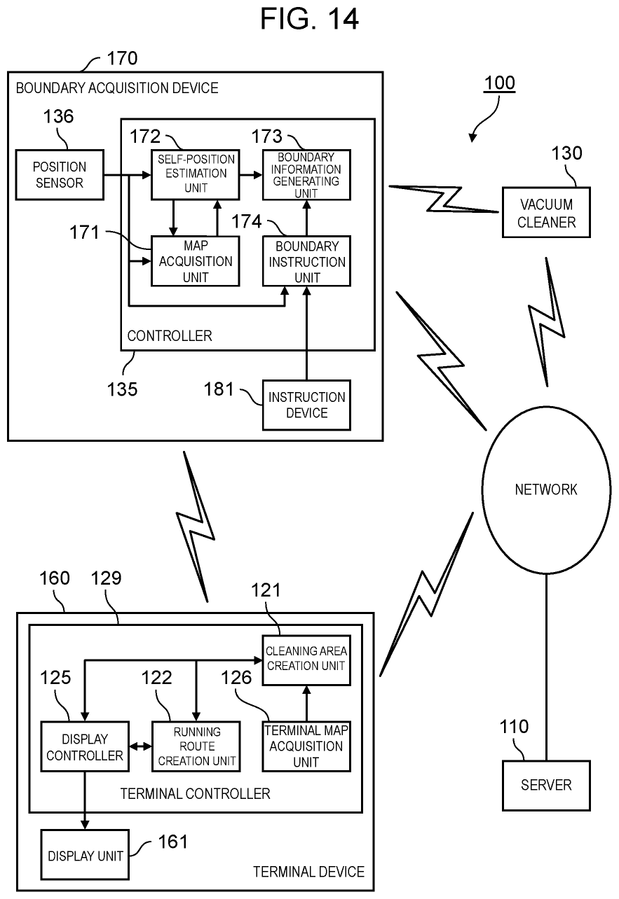

FIG. 13 is a perspective view illustrating boundary acquisition device 170. FIG. 14 is a block diagram illustrating each functional unit of vacuum cleaner system 100 including boundary acquisition device 170. The above exemplary embodiment has exemplified the configuration in which boundary information is created by the running of vacuum cleaner 130. However, boundary information may be acquired on the basis of boundary acquisition device 170 including no cleaning function as illustrated in FIG. 13. As illustrated in FIG. 14, boundary acquisition device 170 includes position sensor 136, map acquisition unit 171, self-position estimation unit 172, boundary information generating unit 173, and boundary instruction unit 174. In boundary acquisition device 170, similarly to vacuum cleaner 130 according to the above-described exemplary embodiment, boundary information generating unit 173 creates boundary information on the basis of the information obtained by position sensor 136. Boundary acquisition device 170 includes a communication device (not illustrated) capable of communicating with terminal device 160 and can transmit the created boundary information to terminal device 160. Boundary acquisition device 170 may include grip portion 179 as an operation unit. Grip portion 179 is a constituent element for the user to push and cause boundary acquisition device 170 to run and is a constituent element for the user to change the running direction of boundary acquisition device 170 (position sensor 136). Boundary instruction unit 174 may instruct boundary information generating unit 173 to generate a boundary when the user operates grip portion 179 to change the running direction of boundary acquisition device 170 (position sensor 136). In addition, boundary instruction unit 174 may output an instruction to create boundary information to boundary information generating unit 173 in response to the user operating instruction device 181 such as a push button attached to grip portion 179.

In addition, boundary acquisition device 170 may include a sensor such as a wheel odometry or a gyro sensor.

When having boundary acquisition device 170 as a dummy of vacuum cleaner 130, vacuum cleaner system 100 can determine cleaning areas for each floor 201 by, for example, generating boundary information for each of the plurality of floors 201 using boundary acquisition device 170. Accordingly, vacuum cleaner system 100 can output a running route based on each cleaning area to vacuum cleaner 130 in charge of each floor 201. This makes it possible to efficiently start up vacuum cleaner system 100.

Although the present exemplary embodiment has exemplified the configuration in which vacuum cleaner system 100 includes terminal device 160, vacuum cleaner system 100 may not include terminal device 160. At least one of vacuum cleaner 130, boundary acquisition device 170, and server 110 may include all or some of the functions of terminal device 160. Similarly, at least one of vacuum cleaner 130, terminal device 160, and server 110 may include some or all of the processing units implemented by executing programs.

Although the present exemplary embodiment has exemplified the configuration that creates rectangular cleaning areas, cleaning areas can have shapes other than rectangular shapes depending on the shapes of wall surfaces or the shapes of furniture and the like arranged on floor 201.

Although the present exemplary embodiment has exemplified the case in which boundary information is created using one vacuum cleaner 130 and one boundary acquisition device 170, boundary information may be created by causing a plurality of vacuum cleaners 130 and a plurality of boundary acquisition devices 170 to run. In this case, terminal device 160 may create cleaning areas by integrating information from the plurality of vacuum cleaners 130 and the plurality of boundary acquisition devices 170.

The present disclosure is applicable to a vacuum cleaner system including an autonomous vacuum cleaner.

What is claimed is:

1. A vacuum cleaner system including a vacuum cleaner that autonomously runs in a predetermined floor and performs cleaning, the system comprising:
a position sensor that acquires a positional relationship between the vacuum cleaner and an object around the vacuum cleaner;
a map acquisition unit that acquires a floor map indicating the predetermined floor;
a self-position estimation unit that estimates a self-position on the floor map based on the position sensor, the self-position being a position of the vacuum cleaner;
a boundary information generation unit that acquires, based on the self-position, boundary information indicating a boundary of a cleaning area which is an area where the vacuum cleaner performs cleaning on the floor;
a boundary instruction unit that instructs the boundary information generation unit on the boundary;
a cleaning area creation unit that creates the cleaning area based on the boundary information; and
a running route creation unit that creates a running route for cleaning based on the created cleaning area.

2. The vacuum cleaner system according to claim 1, further comprising:
a running unit that moves the position sensor; and
an operation unit that moves the position sensor based on an input from a user.

3. The vacuum cleaner system according to claim 2, wherein the boundary instruction unit instructs the boundary information generating unit on the boundary based on a change in a running direction of the position sensor.

4. The vacuum cleaner system according to claim 1, wherein the boundary instruction unit instructs the boundary information generating unit on the boundary based on detection of a maker placed on the floor.

5. The vacuum cleaner system according to claim 1, wherein the boundary instruction unit instructs the boundary information generating unit on the boundary based on an input from a user.

6. The vacuum cleaner system according to claim 1, further comprising a boundary acquisition device in which the position sensor, the map acquisition unit, the self-position estimation unit, the boundary information generating unit, and the boundary instruction unit are mounted.

7. A vacuum cleaner included in the vacuum cleaner system defined in claim 1, the vacuum cleaner comprising the position sensor, the map acquisition unit, the self-position estimation unit, the boundary information generating unit, and the boundary instruction unit.
